(19) United States
(12) Patent Application Publication
(10) Pub. No.: US 2026/0160705 A1
(43) Pub. Date: Jun. 11, 2026

(54) SYSTEMS AND METHODS FOR PHASE-SHIFT INTERFEROMETRY UTILIZING LOGARITHMIZED PROBABILITY DENSITY FIT OF PHASE SHIFT INTERFERENCE DATA

(71) Applicant: GlobalWafers Co., Ltd., Hsinchu (TW)

(72) Inventors: Benno Orschel, Frontenac, MO (US); Markus Jan Peter Siegert, Key West, FL (US); Uwe Hermes, Portland, OR (US); Andrey Melnikov, Huntington Valley, PA (US)

(21) Appl. No.: 19/265,560

(22) Filed: Jul. 10, 2025

Related U.S. Application Data
(60) Provisional application No. 63/669,971, filed on Jul. 11, 2024.
(60) Provisional application No. 63/669,956, filed on Jul. 11, 2024.

(51) Int. Cl. G01N 21/95; G01N 21/01; G06T 7/00; G06T 7/55

(52) U.S. Cl. CPC G01N 21/9501; G01N 21/01; G06T 7/0004; G06T 7/55; G01N 2021/0137; G06T 2207/10028; G06T 2207/30148

(57) ABSTRACT

A computer device includes at least one processor in communication with at least one memory device. The at least one processor is programmed to: a) receive scan data of a sample to be analyzed for phase shift interferometry (PSI); b) for each pixel of the plurality of pixels, i) generate a sequence of interferences for a corresponding pixel of the plurality of pixels; ii) generate a wave form from the sequence of interferences for the corresponding pixel; iii) generate an approximated waveform based on the wave form and a non-normal distributed statistical distribution; iv) extract a phase from the approximated waveform; and c) generate a phase image from the plurality of phases from each pixel of the plurality of pixels.

### CROSS REFERENCE TO RELATED APPLICATIONS

This application claims the benefit of and priority to U.S. Provisional Application No. 63/669,971, filed Jul. 11, 2024, and to U.S. Provisional Application No. 63/669,956, filed Jul. 11, 2024, which applications are hereby incorporated by reference in their entireties.

### FIELD

The field of the disclosure relates to interferometry images of semiconductor wafers and, more particularly, to systems and methods to implement phase detection algorithms for non-normal distributed measurement errors of phase-shift interferometry images of semiconductor wafers.

### BACKGROUND

Known phase detection algorithms used in phase-shift-interferometry (PSI) for semiconductor wafer inspection and analysis today all fit interference intensity data assuming normal distributed measurement errors is correct only in cases where the sample is free of vibrations. In such cases, measurement errors are mainly due to sensor noise and assuming normal distributed errors is reasonable.

However, after inserting a semiconductor (e.g., silicon) wafer into the interferometer, there are very large vibrations and one must wait until these initial vibrations disappear. In the presence of vibrations, the error mean is negative at the interference intensity maxima, positive at the interference intensity minima, and zero at the mean interference intensity. After that, the wafer is almost vibration free but is still picking up at least sound waves from the environment and possibly also vibrations through the frame and support of the interferometer. It is not uncommon in a typical manufacturing environment to see individual frames with large vibration amplitude in a sequence of apparently vibration free frames. However, it is important to realize, that even those frames that appear to be vibration free may still be impacted by low amplitude vibrations, resulting in some small distortion of the interference wave form. Furthermore, in situations where the camera integration time is large enough to cover many vibration periods and the vibration amplitude less than a π/2 phase shift, this results in a clipping effect on the recorded interference wave form.

Accordingly, a system to account for the non-normalized distribution of PSI data is needed.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system includes a computing device that may include at least one processor in communication with at least one memory device. The at least one processor may be configured to: a) receive scan data of a sample to be analyzed for phase shift interferometry (PSI), wherein the scan data includes a plurality of images of the sample, wherein each image includes a plurality of pixels; b) for each pixel of the plurality of pixels, i) generate a sequence of interferences for a corresponding pixel of the plurality of pixels; ii) generate a wave form from the sequence of interferences for the corresponding pixel; iii) generate an approximated waveform based on the wave form and a non-normal distributed statistical distribution; iv) extract a phase from the approximated waveform; and c) generate a phase image from the plurality of phases from each pixel of the plurality of pixels. The system may have additional, less, or alternate functionalities, including those discussed elsewhere herein.

In another aspect, a computer-implemented method may be performed by a computer device including at least one processor in communication with at least one memory device. The method may include a) receiving scan data of a sample to be analyzed for phase shift interferometry (PSI), wherein the scan data includes a plurality of images of the sample, wherein each image includes a plurality of pixels; b) for each pixel of the plurality of pixels, i) generating a sequence of interferences for a corresponding pixel of the plurality of pixels; ii) generating a wave form from the sequence of interferences for the corresponding pixel; iii) generating an approximated waveform based on the wave form and a non-normal distributed statistical distribution; iv) extracting a phase from the approximated waveform; and c) generating a phase image from the plurality of phases from each pixel of the plurality of pixels. The method may have additional, less, or alternate functionalities, including those discussed elsewhere herein.

In a further aspect, a computer device includes at least one processor in communication with at least one memory device. The at least one processor may be configured to: a) receive scan data of a sample to be analyzed for phase shift interferometry (PSI), wherein the scan data includes a plurality of images of the sample, wherein each image includes a plurality of pixels; b) generate a wave function for the scan data; c) determine a non-normal distributed statistical distribution for the scan data; d) generate an approximated waveform based on the wave function and the non-normal distributed statistical distribution; e) analyze the approximated waveform of the object to be analyzed; and f) determine whether or not to approve the object based on the analysis. The computer device may have additional, less, or alternate functionalities, including those discussed elsewhere herein.

In another aspect, at least one non-transitory computer-readable media having computer-executable instructions embodied thereon, when executed by a computing device including at least one processor in communication with at least one memory device, the computer-executable instructions may cause the at least one processor to: a) receive scan data of a sample to be analyzed for phase shift interferometry (PSI), wherein the scan data includes a plurality of images of the sample, wherein each image includes a plurality of pixels; b) for each pixel of the plurality of pixels, i) generate a sequence of interferences for a corresponding pixel of the plurality of pixels; ii) generate a wave form from the sequence of interferences for the corresponding pixel; iii) generate an approximated waveform based on the wave form and a non-normal distributed statistical distribution; iv) extract a phase from the approximated waveform; and c) generate a phase image from the plurality of phases from each pixel of the plurality of pixels. The non-transitory computer-readable media may have additional, less, or alternate functionalities, including those discussed elsewhere herein.

In one additional aspect, a system includes a computing device that may include at least one processor in communication with at least one memory device. The at least one processor may be configured to: a) receive scan data of an object to be analyzed for phase shift interferometry (PSI); b) for each pixel of the plurality of pixels, i) generate a sequence of interferences for a corresponding pixel of the plurality of pixels; ii) generate a model from the sequence of interferences for the corresponding pixel; iii) fit the model with a weighted least squares method; iv) extract a phase from the fitted model; and c) generate a phase image from the plurality of phases from each pixel of the plurality of pixels. The system may have additional, less, or alternate functionalities, including those discussed elsewhere herein.

In another aspect, a computer-implemented method may be performed by a computer device including at least one processor in communication with at least one memory device. The method may include a) receiving scan data of an object to be analyzed for phase shift interferometry (PSI); b) for each pixel of the plurality of pixels, i) generating a sequence of interferences for a corresponding pixel of the plurality of pixels; ii) generating a model from the sequence of interferences for the corresponding pixel; iii) fitting the model with a weighted least squares method; iv) extracting a phase from the fitted model; and c) generating a phase image from the plurality of phases from each pixel of the plurality of pixels. The method may have additional, less, or alternate functionalities, including those discussed elsewhere herein.

In a further aspect, a computer device includes at least one processor in communication with at least one memory device. The at least one processor may be configured to: a) receive scan data of an object to be analyzed for phase shift interferometry (PSI); b) for each pixel of the plurality of pixels, i) generate a sequence of interferences for a corresponding pixel of the plurality of pixels; ii) generate a model from the sequence of interferences for the corresponding pixel; iii) fit the model with a weighted least squares method; iv) extract a phase from the fitted model; and c) generate a phase image from the plurality of phases from each pixel of the plurality of pixels. The computer device may have additional, less, or alternate functionalities, including those discussed elsewhere herein.

In another aspect, at least one non-transitory computer-readable media having computer-executable instructions embodied thereon, when executed by a computing device including at least one processor in communication with at least one memory device, the computer-executable instructions may cause the at least one processor to: a) receive scan data of an object to be analyzed for phase shift interferometry (PSI); b) for each pixel of the plurality of pixels, i) generate a sequence of interferences for a corresponding pixel of the plurality of pixels; ii) generate a model from the sequence of interferences for the corresponding pixel; iii) fit the model with a weighted least squares method; iv) extract a phase from the fitted model; and c) generate a phase image from the plurality of phases from each pixel of the plurality of pixels. The non-transitory computer-readable media may have additional, less, or alternate functionalities, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed. Each Figure depicts an embodiment of a particular aspect of the disclosed systems and methods, and that each of the Figures is intended to accord with a possible embodiment. Further, wherever possible, the following description refers to the reference numerals included in the following Figures, in which features depicted in multiple Figures are designated with consistent reference numerals.

FIG. 1 illustrates a diagram of a system for performing phase shift interferometry (“PSI”) to detect irregularities on a surface of a wafer.

FIG. 2 illustrates a diagram of another system for performing phase shift interferometry (“PSI”) to detect irregularities on surfaces on both sides of a wafer both shown in FIG. 1, simultaneously.

FIG. 3 illustrates an image taken by the image capture device without a wafer shown in FIG. 1.

FIG. 4 illustrates an image taken by the image capture device with a wafer shown in FIG. 1.

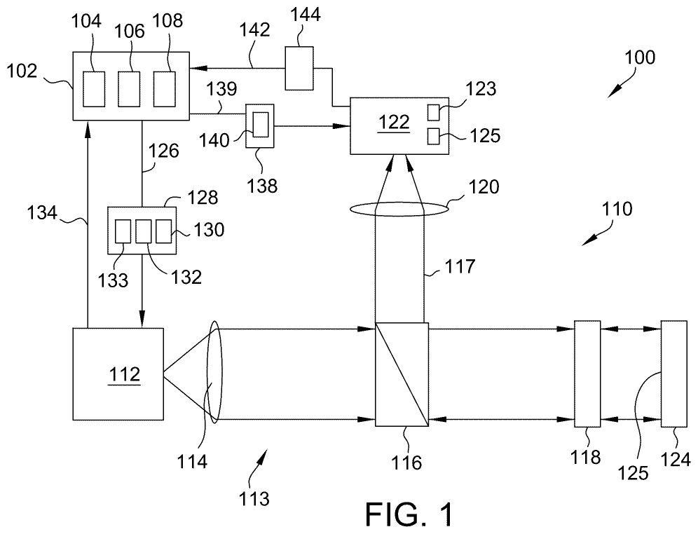

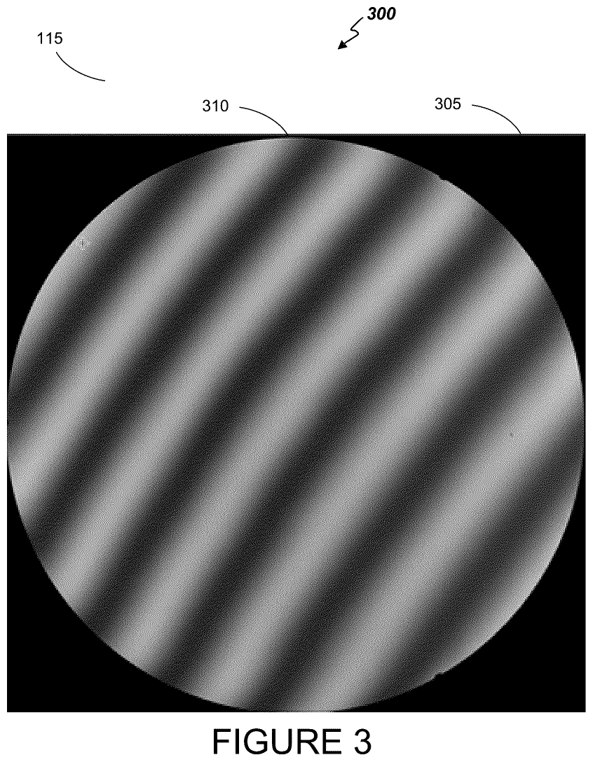

FIG. 3 illustrates an image taken by the image capture device without a wafer shown in FIG. 1.

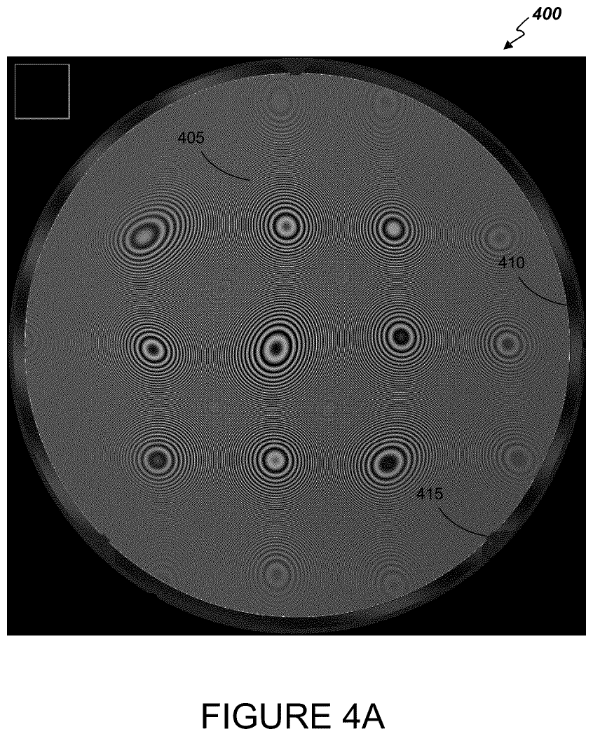

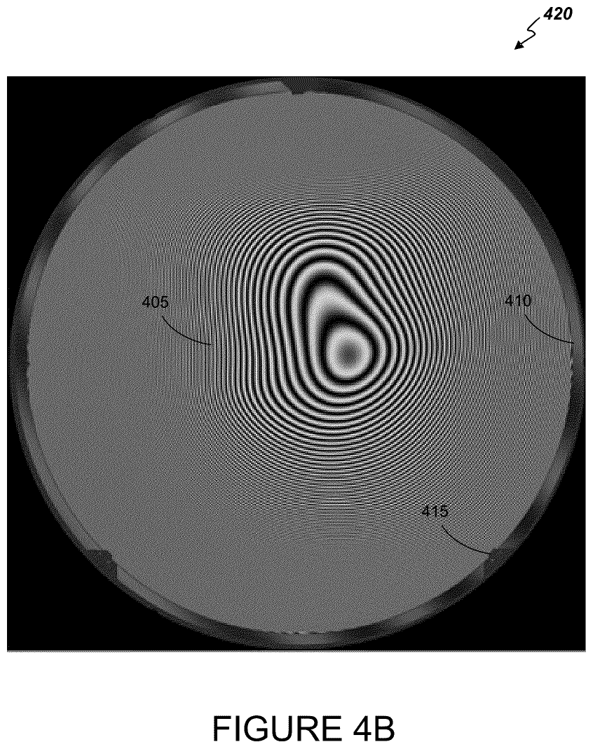

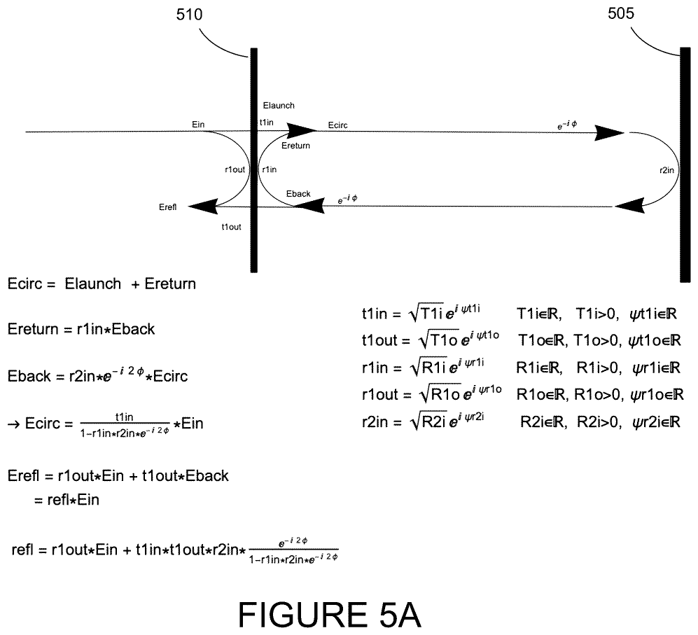

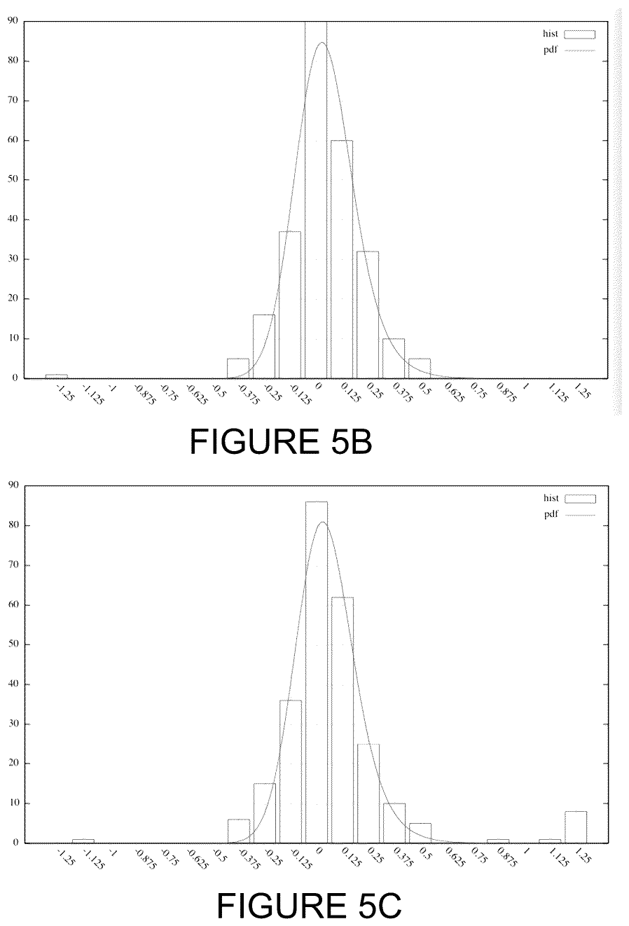

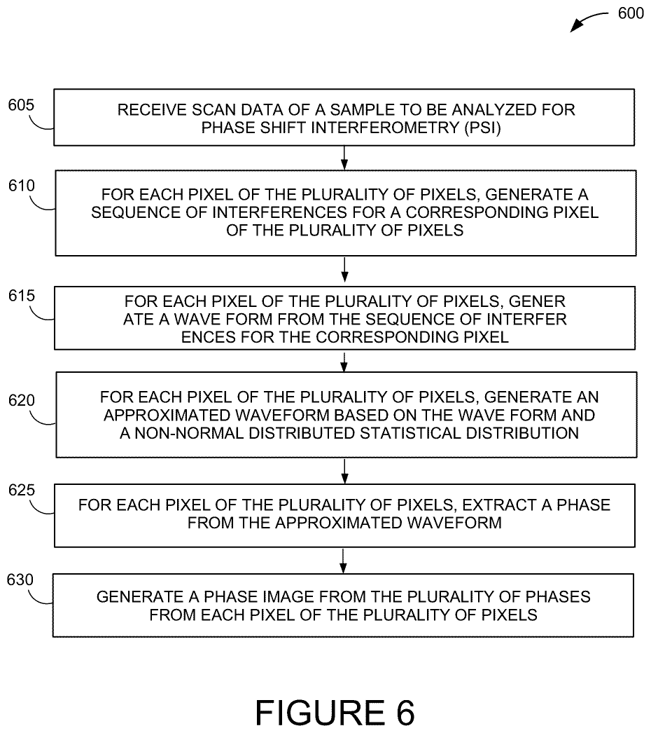

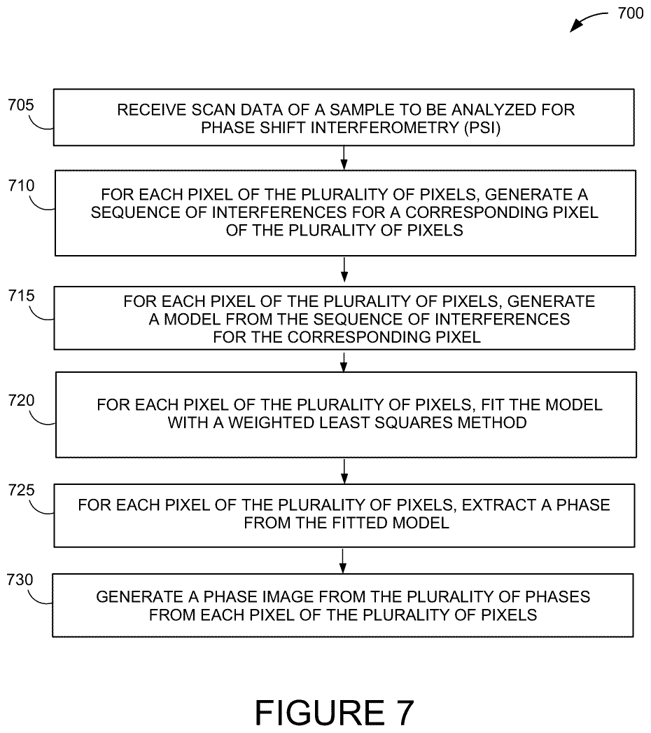

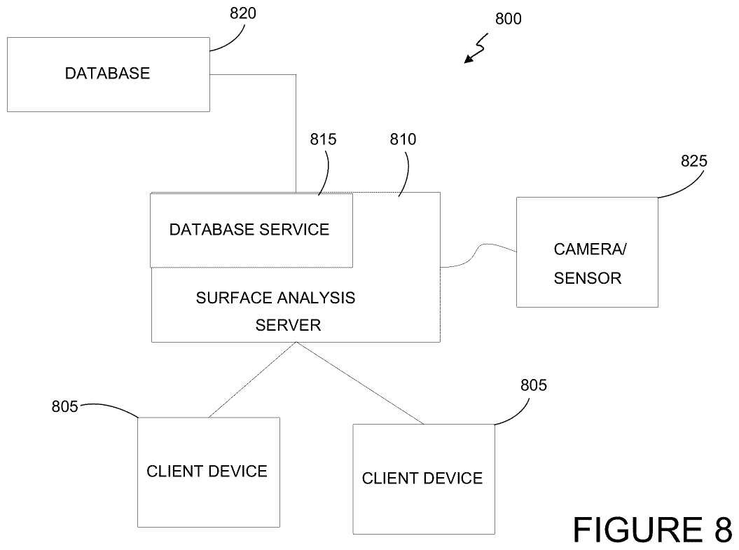

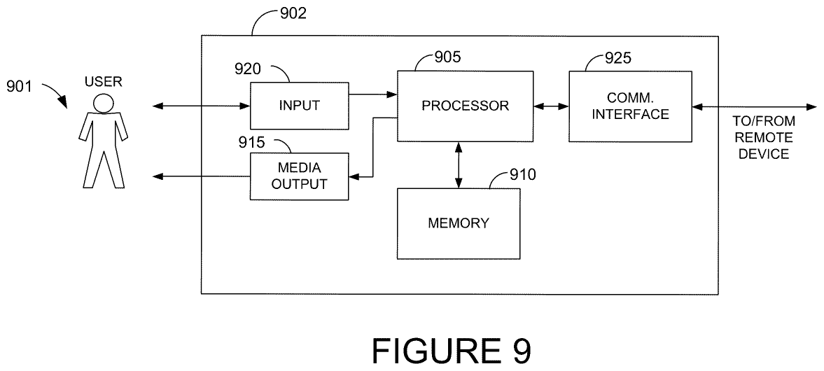

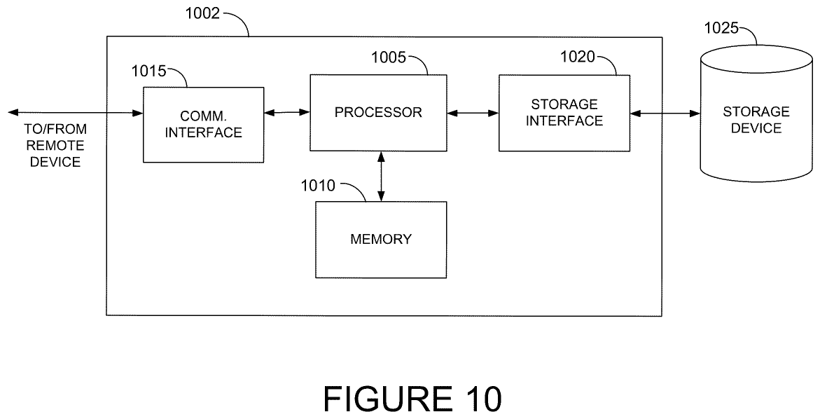

FIG. 4A illustrates an image 400 taken by the image capture device of a front side of a wafer both shown in FIG. 1.

FIG. 4B illustrates another image taken by the image capture device of a back side of a wafer both shown in FIG. 1.

FIG. 5A illustrates a diagram showing the light paths, electric fields, and reflectivity coefficients (all of which are complex values), in accordance with at least one embodiment.

FIG. 5B illustrates a histogram of error distribution for fitting with non-normal distributed probability-density function as in EQ. 12 in all scans and all pixels in the absence of wafer vibration.

FIG. 5C illustrates a histogram of error distribution for fitting with non-normal distributed probability-density function as in EQ. 12 in all scans and all pixels with simulated wafer vibration.

FIG. 6 illustrates a process for phase shift interferometry utilizing logarithmized probability density fit of phase interference data.

FIG. 7 illustrates a process for performing phase shift interferometry in which a robust least squares fit of a simple sine wave model with a custom robust weighting function applied.

FIG. 8 illustrates an example system for performing the processes shown in FIGS. 6 and 7.

FIG. 9 illustrates an example configuration of a user computer device.

FIG. 10 illustrates an example configuration of a server computer device.

Like reference symbols in the various drawings indicate like elements.

### DETAILED DESCRIPTION

The field of the disclosure relates to interferometry images of semiconductor wafers and, more particularly, to systems and methods to implement phase detection algorithms for non-normal distributed measurement errors of phase-shift interferometry images of semiconductor wafers. Furthermore, the present disclosure relate to systems and methods for performing phase shift interferometry (PSI) which fit a normalized approximation of the full model of the distorted Airy-distribution wave form. The normalized approximation correctly reproduces the wave form of the distorted Airy distribution. Embodiments of the present disclosure also use a non-normal distributed error statistic model for data fitting and using a custom error function that produces an error distribution that is like the model distribution.

After inserting a semiconductor (e.g., silicon) wafer into the interferometer, there are very large vibrations and one must wait until these initial vibrations disappear. After that, the wafer is almost vibration free but is still picking up at least sound waves from the environment and possibly also vibrations through the frame and support of the interferometer. It is not uncommon in a typical manufacturing environment to see individual frames with large vibration amplitude in a sequence of apparently vibration free frames. However, it is important to realize, that even those frames that appear to be vibration free may still be impacted by low amplitude vibrations, resulting in some small distortion of the interference wave form. In the presence of vibrations, the error mean is negative at the interference intensity maxima, positive at the interference intensity minima, and zero at the mean interference intensity.

In cases where the camera integration time is large enough to cover many vibration periods and the vibration amplitude less than a π/2 phase shift, this results in a clipping effect on the recorded interference wave form. At the inflection points, the measured intensity would be not affected. If the camera integration time is very short compared to the vibration time or the vibration amplitude is more than a π/2 phase shift, the measured intensity at any point of the interference wave can randomly deviate strongly from its nominal value. At intensity maxima (minima) the measured intensities would be only less (more) than the nominal value.

The primary issue to be solved is trying to fit a shape that looks like a sine wave, but isn't exactly a sine wave. The issue is trying to fit that data with systematic differences in noise distribution depending on where in the phase of the whole period the measurements are being taken. This causes a misfit or inappropriate fit that results in an error in the resulting fit. Accordingly, the system is trying to fit a curve to the data to find out what the phase is with respect to time. Time collates with laser voltage which collates with laser wavelength. This information is used to generate the surface maps.

In this distribution of noise, the zero transitions are evenly distributed up and down. However, for the maxima and the minima, the noise distribution is not evenly distributed. On the maxima, it is only distributed downward. On the minima, it is only distributed upwards.

With respect to phase error, this phenomenon creates the biggest phase error in multi-reflection interferometers (i.e., Fizeau-interferometers), because there, due to internal resonance enhancement and due to phase shifts during transmission (in and out) and inner and outer reflections at the mixed metal-dielectric surface coating of the reference plane, the interference wave form is a distorted Airy-distribution. If such a distorted Airy-distribution wave form is distorted by temporary vibrations in individual frames, the resulting phase error is also not normal distributed, regardless of whether a Fourier transform or fitting algorithm is used. This is often visible in form of so-called “fringe-print-through” patterns.

There are other strategies to potentially address this problem. First, sample vibrations can be dampened by attaching mechanical dampers to the edge of the sample. This strategy is partially successful, but acoustic waves still can excite the inside of a thin sample of large area (i.e., silicon wafer). Second, camera exposure time can be reduced. This strategy cannot be successful, because even with infinitesimally small exposure intervals, the snapshots of a series of interference frames still are subject to the above described non-normal error distribution at the wave extremal points and in addition incurs larger intensity errors at the inflection points.

A third strategy is to fit the interference wave with higher order harmonics. This strategy deals with constant vibrations that are present throughout the wavelength scan. This is not applicable to the situation when the sample (wafer) picks up random vibrations from the environment.

Another problem is the non-sinusoidal wave form of the interference intensity scan, due to multiple reflections in the interferometer. Another solution was to use specially tailored phase step algorithms and the use of data sampling window Fourier transform.

A further attempt at a solution includes using a Taylor series of the Airy distribution. However, this approach neglects the fact, that as a result of metal-dielectric coatings, the reflection phase shift is not 180 degrees and the resulting wave form is a distorted Airy distribution.

Contrary to known methods, the systems and methods described herein implement an algorithm or model for performing phase shift interferometry which fit a normalized approximation of the full model of the distorted Airy-distribution wave form. The normalized approximation correctly reproduces the wave form of the distorted Airy distribution. Embodiments of the present disclosure also use a non-normal distributed error statistic model for data fitting and using a custom error function that produces an error distribution that is like the model distribution.

Additional embodiments describe systems and methods for performing phase shift interferometry in which a robust least squares fit of a simple sine wave model with a custom robust weighting function is applied to solve the above issues.

Systems and methods implementing the algorithms of the present disclosure can be used for inspection of any suitable semiconductor wafer product. Such systems and methods may suitably be used to characterize wafer thickness, shape, flatness metrics, and nanotopography of the wafer. While the above describes using the systems and processes described herein for analyzing silicon wafers, one having ordinary skill in the art would understand that these systems and methods may also be used for analyzing other surfaces.

FIG. 1 illustrates a diagram of a system 100 for performing phase shift interferometry (“PSI”) to detect irregularities on a surface 125 of a wafer 124. System 100 includes an analyzer device 102 and an interferometer 110. Analyzer device 102 includes a plurality of computing devices, including a first computing device 104, a second computing device 106, and a third computing device 108. In other implementations, analyzer device 102 includes a different number of computing devices. Interferometer 110, which in at least some implementations, is a Fizeau interferometer, includes a light source 112, a first lens 114, a beam splitter 116, a reference plane 118, a second lens 120, and an image capture device 122, such as a camera. In operation, wafer 124, which is for example a silicon wafer, is placed opposite light source 112.

Reference plane 118, which is semi reflective, is disposed between light source 112 and wafer 124. Beam splitter 116 is disposed between light source 112 and reference plane 118. During operation of system 100, light source 112 emits a light beam 113, which passes through first lens 114. A first portion of light beam 113 is reflected by reference plane 118. A second portion is transmitted through semi-reflective reference plane 118 and reflected by surface 125 of wafer 124. Beam splitter 116 directs the reflected light 117 (e.g., the first portion and the second portion) towards image capture device 122. The reflected light 117 passes through second lens 120 to image capture device 122 which samples reflected light 117.

Analyzer device 102 is communicatively coupled to light source 112 and image capture device 122. More specifically, analyzer device 102 transmits light source instruction signals 126 to light source 112. Light source instruction signals 126 include light source instructions 128. Light source instructions 128 include a control function for cyclically emitting different wavelengths 130, for example as a function of time and/or a number of samples that have been obtained. In some implementations, wavelengths 130 is a range or set of wavelengths, and instructions 128 additionally include a currently selected wavelength 132, and a time period 133 during which light 113 is to be emitted at each of the wavelengths 130. Accordingly, light source 112 cycles through wavelengths 130, starting with selected wavelength 132, and emits each wavelength 130 for the time period 133. In at least some implementations, light source 112 transmits a response signal 134, for example acknowledging receipt of light source instruction signal 126.

Analyzer device 102 transmits image capture instruction signals 136 to image capture device 122. Image capture instruction signals 136 include image capture instructions 138. Image capture instructions 138 include an exposure time 140, representing an amount of time that image capture device 122 is to receive reflected light 117 to generate a sample 144. Image capture device 122 transmits image signals 142 to analyzer device 102. Image signals 142 include samples 144 generated by image capture device 122 by receiving reflected light 117 during exposure time 140. As described in more detail, image capture device 122 repeatedly captures reflected light 117 during repeated exposure times 140. Additionally, image capture device 122 performs the capture of reflected light 117 for each of a plurality of light sensors 123, for example charge coupled devices (CCDs), included in image capture device 122. Light sensors 123 are associated with respective pixels 125, described in more detail herein. While system 100 includes an interferometer 110, other implementations do not include interferometer 110 and instead project a moving fringe pattern (e.g., light 117) onto surface 125, as described in more detail herein.

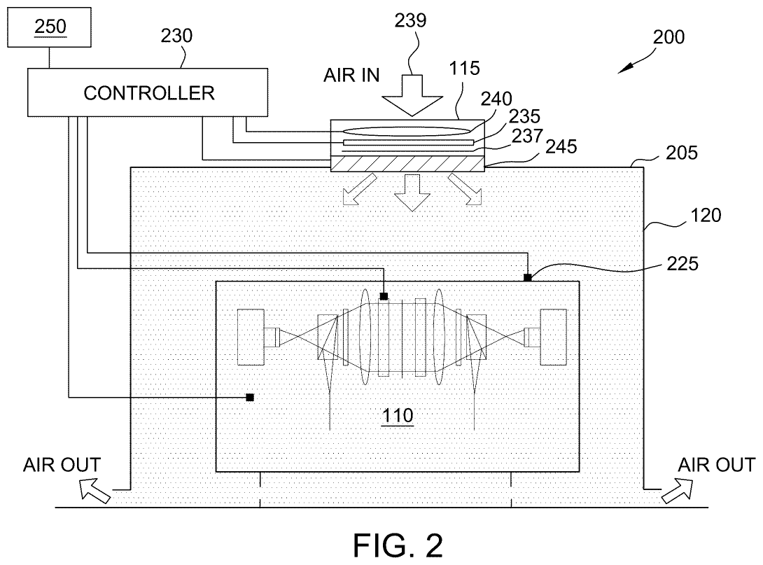

FIG. 2 illustrates a diagram of another system 200 for performing phase shift interferometry (“PSI”) to detect irregularities on surfaces 125 on both sides of a wafer 124 (both shown in FIG. 1) simultaneously. In some embodiment, system 100 is a part of system 200. Whereas the inventive concept can be employed in conjunction with many types of temperature- and vibration-sensitive equipment (as an example, medical instrumentation), the invention will be illustrated herein with an embodiment directed to interferometric measurement systems. The embodiment of FIG. 2 a takes advantage of an existing system that has skin panels 205 which enclose interferometers 110 to create an enclosed minienvironment having forced air circulation. This system 200 may be modified as follows: the air circulation unit 215 that delivers air into the enclosure 220 may be modified such that the temperature and the speed of its output to the enclosure 220 are controllable. Note that varying the speed of air circulation or the fan speed changes the amplitude and the frequency of the acoustic noise and mechanical vibration. Multiple temperature sensors 225 may be mounted on interferometers 110 or at any other positions where temperature control is desired. Thus the positioning of the sensors 225 can be customized according to the details of the measurement or metrology system within the enclosure 220, to provide more accurate temperature feedback to control unit 230. A heating element 235 may be inserted between fan 240 and air filter 245 of unit 215. Optional cooling element 137 may be inserted at any position near air inlet 239. Computer 250 may connect to control unit 230, and may also be used for data acquisition. Control unit 230 controls heating element 235, cooling element 237, and speed of fan 240. In some embodiments, a single heating element 235 and a single cooling element 237 provides sufficient temperature control, and the multiple sensors 225 provide accurate temperature measurement at multiple points of interest.

Note that the configuration shown in FIGS. 1 and 2 are exemplary and not limiting. For example, in contrast to how it is shown in FIG. 2, the fan that blows air into the mini-enclosure 220 is not required to be directly at an opening, i.e., proximal, to the mini-enclosure 220. It can be placed in a position removed from the mini-enclosure 220, and a duct (not shown) can be used to bring air into the mini-enclosure 220. In such a case, the air circulation would still cause vibration and acoustic noise.

FIG. 3 illustrates an image 300 taken by the image capture device 122 without a wafer 124 (both shown in FIG. 1). More specifically, image 300 shows the background 305 of the enclosure 220 (shown in FIG. 2). The background 305 of the enclosure 220 has the potential to change over time due to temperature and other factors. Accordingly, the systems and methods described herein are configured to account for those changes in real-time.

FIG. 4A illustrates an image 400 taken by the image capture device 122 of a front side of a wafer 124 (both shown in FIG. 1). More specifically, image 400 shows the wafer image 405 of the wafer 124. Image 400 also includes the background 305 (shown in FIG. 3) of the enclosure 220 (shown in FIG. 2) in a ring 410 around the wafer image 405. Image 400 also includes the wafer grippers 415 that hold the wafer 124 vertically. The wafer image 405 and the background ring image 410 are used with the systems and methods described herein.

FIG. 4B illustrates another image 420 taken by the image capture device 122 of a back side of a wafer 124 (both shown in FIG. 1). More specifically, image 400 shows the wafer image 405 of the wafer 124. Image 400 also includes the background 305 (shown in FIG. 3) of the enclosure 220 (shown in FIG. 2) in a ring 410 around the wafer image 405. Image 400 also includes the wafer grippers 415 that hold the wafer 124 vertically. The wafer image 405 and the background ring image 410 are used with the systems and methods described herein.

FIG. 5A illustrates a diagram 500 showing the light paths, electric fields, and reflectivity coefficients (all of which are complex values), in accordance with at least one embodiment. Coming into the interferometer 110 is the laser beam Ein, which is partially reflected with reflectivity r1out at the reference plane 510. The portion that passes is Elaunch=t1in*Ein. The light then circulates inside the interferometer 110 between sample surface 505 with reflectivity r2in and inside surface of the reference plane 118 with reflectivity r1in. Travelling between the 2 surfaces imposes a distance and wavelength dependent phase shift e\hat{ }-i phi in each direction. The electric field Eback is that of the light reflected on the sample surface. Ereturn is the portion r1in*Eback which is reflected back into the interferometer. Ecirc is the circular field of the combination of all generations of reflections inside the interferometer. The portion t1out*Eback which leaves the interferometer recombines with the initially reflected portion r1out*Ein into Erefl.

The bottom formula refl= . . . is the resulting interferometer reflectivity, which is a function of phi, which is dependent on wavelength and sample-reference plane distance. This is the basis for developing EQ. 6, which is a normalized (very close) approximation of the actual interference wave form.

This happens in every location of the wafer that is captured by one camera pixel. Because phi in this formula is dependent on laser wavelength and reference-sample distance, this allows for measuring relative distance deltas from pixel to pixel by scanning the laser wavelength.

The solution described herein is based on the reference 505 and the sample 510. In the example embodiment, the sample 505 is the wafer 124 (shown in FIG. 1). The solution described herein a uses non-normal distribution noise function. This is fit so that the model thinks that the noise distribution is matched. The residual base error becomes smaller, otherwise periodic phase errors show up as fringe print.

The interferometer reflectivity is:

$$R = R 1 o ( 1 + \frac{4 β ( β - Cos [ ψ ] - α Cos [ Φ + ψ ] )}{1 + {α}^{2} - 2 α Cos [ Φ ]} ) \qquad EQ . 1$$

$$with$$

$$ψ = ( ψ rli + ψ r 1 o - ψ t 1 i - ψ t 1 o ) \qquad EQ . 2$$

$$Φ = 2 ϕ - ψ r 1 i - ψ r 2 i \qquad EQ . 3$$

$$α = \frac{1}{\sqrt{R 1 iR 2 i}} \qquad EQ . 4$$

$$β = \sqrt{\frac{T 1 i T 1 o}{4 Rli Rlo}} \qquad EQ . 5$$

The intensity that is recorded by a camera is interferometer reflectivity times a gain, which accounts for laser intensity, optical path losses and camera sensitivity.

$$Icam = Gain * R = Gain R 1 o ( 1 + \frac{4 β ( β - Cos [ ψ ] - α Cos [ Φ + ψ ] )}{1 + {α}^{2} - 2 α Cos [ Φ ]} ) \qquad EQ . 6$$

In at least one embodiment, a metal-dielectric coating of the reference surface results in a ψ=−1.78, resulting in a slanted interference wave form. To approximate the exact wave form, EQ. 6 can be written to after

$$Icam - I 0 + I 1 \frac{α Cos [ ψ ] + Cos [ Φ ]}{1 + {α}^{2} + 2 α Cos [ Φ + ψ ]} \qquad EQ . 7$$

with redefined α, Φ, and ψ.

$$ψ = - ( ψ rli + ψ r 1 o - ψ t 1 i - ψ t 1 o ) \qquad EQ . 8$$

$$Φ = 2 ϕ - ψ r 1 i - ψ r 2 i + ψ \qquad EQ . 9$$

$$α = \sqrt{R 1 iR 2 i} \qquad EQ . 10$$

The approximated wave form sufficiently reproduces the shape of the correct wave form. The benefit of this approximation is, that it can be normalized to range from −1 to +1. (Trying to normalize the exact form turns out to be computationally significant.)

The offset of the term

$$\frac{α Cos [ ψ ] + Cos [ Φ ]}{1 + {α}^{2} + 2 α Cos [ Φ + ψ ]}$$

$$is$$

$$\frac{- 1 + α Cos [ ψ ]}{- 1 + {α}^{2}}$$

and the range is

$$\frac{- 1 + α Cos [ ψ ]}{- 1 + {α}^{2}} .$$

With this, it can be normalized to range from −1 to +1. The normalized term is

$$Inorm = \frac{Cos [ Φ ] + α ( 2 Cos [ ψ ] + α Cos [ Φ + 2 ψ ] )}{1 + {α}^{2} + 2 αCo s [ Φ + ψ ]} \qquad EQ . 11$$

This normalization dramatically simplifies fitting the measured data. The minima and maxima of an interference scan is found and the measured data is transformed to range −1 . . . +1. Then EQ. 11 is fit to the normalized data, searching only for Φ, with α and Ψ being known values (determined by the properties of sample material Si and reference plane metal-dielectric surface coating).

Next the non-normal distributed error statistic is determined. As error distribution model, the following probability density function (PDF) is used:

$$P D {F}_{i} ( λ , σ ) = \frac{1}{2 λ} {e}^{\frac{{σ}^{2}}{2 {δ}^{2}} - \frac{{e}_{i} - 0}{δ}} e r f c ( \frac{1}{\sqrt{2}} ( \frac{σ}{δ} - \frac{{e}_{i} - o}{σ} ) ) \qquad EQ . 12$$

with eᵢ=Iᵢ²−yᵢ² as custom error function.

The most likely set of parameters α, Φ, and ψ is where the product of Π PDFᵢ is at its maximum. β and G1o were previously eliminated. Unfortunately, such product can easily become too large or too small to be representable by today's floating point computing hardware. Therefore, the product is transformed into a sum of logarithms of PDFᵢ since ln(Π PDFᵢ)=Σ ln(PDFᵢ). Numerical stability is further enhanced and at the same time extreme outliers are eliminated by excluding points with ln(PDFᵢ)<minLnPdf from the summation. In some embodiments, minLnPdf=1e-300 is used as a starting value, and then it is increased up to 1e-30 with progressing optimization iterations.

As additional benefit, the first derivatives and Jacobi-matrix can also be directly calculated by summation of individual derivatives of individual ln(PDFᵢ). This eliminates the need for numerical derivatives, which would be less numerically stable and more time consuming.

In order to compare the robustness against temporary vibrations, a nearly perfect wavelength scan is used and the effect of vibration is simulated in several points. The measured phases with and without simulated vibrations are compared as shown in Table 1.

TABLE 1

| Phase Measurement | Phase without | Phase with | Phase |
|---|---|---|---|
| Algorithm | vibrations | vibrations | Delta |
| Fourier Transform | 1.9012 | 1.8825 | −0.0187 |
| Σln(PDF) | 3.1915 | 3.1942 | +0.0027 |
| optimization | | | |

For a LASER wavelength of 635 nm and cavity distance of 25 mm, these phase deltas are equivalent to −0.93 nm in case of traditional phase detection and 0.13 nm for the algorithms of the present disclosure. This means a phase error reduction by factor 6.9.

Parameters α and ψ don't need to be optimized. ψ is determined by the reference plane transmissivity and inner and outer reflectivity and α by outer reference plane reflectivity and known Si reflectivity. Reference plane transmissivity, inner and outer reflectivity, and ψ can be determined by carefully measuring (averaging multiple scans) the cavity and optimizing Σ ln(PDF).

FIG. 5B illustrates a histogram of error distribution for fitting with non-normal distributed probability-density function as in EQ. 12 in all scans and all pixels in the absence of wafer vibration.

FIG. 5C illustrates a histogram of error distribution for fitting with non-normal distributed probability-density function as in EQ. 12 in all scans and all pixels with simulated wafer vibration. The non-normal distributed probability-density function as in EQ. 12 penalizes outliers blow the maxima or above the minima of the wave much less (which is likely due to sample vibration) than outliers above the maxima or below the minima of the wave, which is impossible due to sample vibration, only camera sensor noise can cause that, but camera noise is orders of magnitude smaller than noise due to wafer vibration. That results in far less fit sensitivity to common noise due to sample vibration compared to fitting with normal distributed probability-density function (i.e., least squares fitting). As shown in FIG. 5B, 5C, and Table 1 the phase error is small, which indicates the accuracy of the process 600 (shown in FIG. 6).

Systems and methods implementing the algorithms of the present disclosure can be used for inspection of any suitable semiconductor wafer product. Such systems and methods may suitably be used to characterize wafer thickness, shape, flatness metrics, and nanotopography of the wafer. Furthermore, one having ordinary skill in the art, would understand that the systems and methods described herein could be used for other embodiments, such as, but not limited to, scanning other surfaces with potential vibration.

FIG. 6 illustrates a process 600 for phase shift interferometry utilizing logarithmized probability density fit of phase interference data. In the example embodiment, process 600 is performed by the surface analysis server 810 (shown in FIG. 8). Process 600 provides for the measurement of the surfaces with nanometer accuracy that allows for analysis of those surfaces. In some embodiments, process 600 can be performed on the front and back surfaces of an object, such as a wafer 124 (shown in FIG. 1), simultaneously.

The process 600 uses the full electric field analysis to calculate the actual interference line shape or wave shape shown in EQ. 1. In process 600, the actual model is being fitted, rather than just fitting sample points that are evenly distributed. In process 600, the server 610 scans the whole wave (EQ. 1) and then fits that function with the non-normal distributed statistical distribution. Thereby reducing the residual phase error that would be normally received.

Process 600 combines full line shape analysis with non-normal distributed statistics. Then process 600 uses the normalization. This provides an approximation that is computationally efficient, effectively a non-normal distributed error statistic. This significantly reduces the computational resources required to perform this analysis in real-time. The system will attempt to measure each wafer 124 as quickly as possible. By using the approximation described herein, the analysis of wafers 124 can be performed more quickly than the exact model, but with significantly improved accuracy over known state of the art PSI methods. Not only because the fitting is quick and efficient, but also because the analysis can be performed while the wafer 124 is still vibrating without having to wait for the vibration to stop.

In the exemplary embodiment, the surface analysis server 810 receives 605 receives scan data of an object to be analyzed for phase shift interferometry (PSI). The scan data includes a plurality of images of the sample, such as, but not limited to, 256. Each image includes a plurality of pixels. The scan data is of a surface, potentially of a semiconductor wafer. In some embodiments, the scan data may be, for example, but not limited to, post-polishing nanotopography, silicon on insulator, or Epitaxial wafers. In some embodiments, the scan data includes both sides of the object. The plurality of images includes a first plurality of images of a first side of the sample and a second plurality of images of a second side of the sample. The first plurality of images includes a first plurality of pixels and the second plurality of images includes a second plurality of pixels. In some further embodiments, the surface analysis server 810 analyzes both sides of the object simultaneously. For the purposes of this discussion a scan case refers to the laser wavelength scan while taking a sequence of images. This is being done to create full surface maps.

In the exemplary embodiment, for each pixel of the plurality of pixels, the surface analysis server 810 generates 610 a sequence of interferences for a corresponding pixel of the plurality of pixels. In some embodiments, the surface analysis server 810 normalizes values in the sequence of interferences into a range of +/−1, for each pixel of the plurality of pixels. In some further embodiments, the surface analysis server 810 generates a sequence of interferences for each pixel of the first plurality of pixels and each pixel of the second plurality of pixels. In some embodiments, the surface analysis server 810 eliminates outliers beyond a threshold.

In the exemplary embodiment, for each pixel of the plurality of pixels, the surface analysis server 810 generates 615 a wave form from the sequence of interferences for the corresponding pixel. In some embodiments, the surface analysis server 820 determines one or more parameters of the wave form by properties of a material used for the sample. In further embodiments, the surface analysis server 810 determines one or more parameters of the wave form by a reference plane 510 (shown in FIG. 5) used during scanning.

In the exemplary embodiment, for each pixel of the plurality of pixels, the surface analysis server 810 generates 620 an approximated waveform based on the wave form and a non-normal distributed statistical distribution. In the exemplary embodiment, the surface analysis server 810 applies the same non-normal distributed statistical distribution to the wave forms for all of the plurality of pixels.

In the exemplary embodiment, for each pixel of the plurality of pixels, the surface analysis server 810 extracts 625 a phase from the approximated waveform. In the exemplary embodiment, the surface analysis server 810 generates 630 a phase image from the plurality of phases from each pixel of the plurality of pixels.

In some embodiments, the surface analysis server 810 analyzes the sample using the phase image. The surface analysis server 810 determines whether or not to approve the sample based on the analysis. Further the surface analysis server 810 determines whether or not to adjust one or more devices based on the analysis, such as a grinder and/or a polisher.

In some further embodiments, the surface analysis server 810 determines minima and maxima of the scan data. The surface analysis server 810 also normalizes the scan data into a range from −1 to +1, this includes the minima and maxima.

Systems and methods implementing the algorithms of the present disclosure can be used for inspection of any suitable semiconductor wafer product. Such systems and methods may suitably be used to characterize wafer thickness, shape, flatness metrics, and nanotopography of the wafer. While the above describes using the systems and processes described herein for analyzing silicon wafers, one having ordinary skill in the art would understand that these systems and methods may also be used for analyzing other surfaces.

FIG. 7 illustrates a process 700 for performing phase shift interferometry in which a robust least squares fit of a simple sine wave model with a custom robust weighting function applied. In the example embodiment, process 700 is performed by the surface analysis server 810 (shown in FIG. 8). Process 700 provides for the measurement of the surfaces with nanometer accuracy that allows for analysis of those surfaces. In some embodiments, process 800 can be performed on the front and back surfaces of an object, such as a wafer 124 (shown in FIG. 1), simultaneously.

In contrast to process 600 (shown in FIG. 6), process 700 provides a simple sine and cosine approximation rather than the actual line shape. The sine AND cosine are fitted to obtain the phase, which is coded in the fit parameters a and b in the fitted function f(x)=a*sin(x)+b*cos(x). In some embodiments, the application of the robust least squares fit in accordance with the present disclosure is implemented in single reflection interferometers. In case of Fizeau interferometers, such application can work well as long as the inner reflectivity of the reference plane is very low. If the inner reflectivity is too large, such that the interference wave form becomes an Airy distribution, the simple sine wave model does not apply.

In one embodiment, the model is:

$$Icamera [ i ] = Ioffset + I sin sin ( ω i ) + I cos cos ( ω i ) \qquad EQ . 13$$

and is fitted by weighted least squares method, with all weights set to 1 in the first iteration. In one embodiment, the robust weighting function is:

$$E W ( i ) = Abs ( I sin sin ( ω i ) + I cos cos ( ω i ) - Abs ) Icamera [ i ] - Ioffset ) \qquad EQ . 14$$

If EW(i)>0, the new weight for the next iteration is set to w[i]=exp(−EW(i)), otherwise w[i]=1.

In order to compare the robustness against temporary vibrations, a nearly perfect wavelength scan is used and the effect of vibration in several points is simulated. The measured phase with and without simulated vibrations is compared to determine a phase delta. Table 2 below provides a comparison between traditional Fourier Transform, Least Squares Fit, and the Robust Least Squares Fit in accordance with the present disclosure.

TABLE 2

| Phase Measurement | Phase without | Phase with | Phase |
|---|---|---|---|
| Algorithm | vibrations | vibrations | Delta |
| Fourier Transform | 1.9012 | 1.8825 | −0.0187 |
| LS Fit | 1.7713 | 1.7841 | +0.0128 |
| Robust LS Fit | 1.7737 | 1.7765 | +0.0028 |

For a LASER wavelength of 635 nm and cavity distance of 25 mm, these phase deltas are equivalent to −0.93 nm in case of traditional phase detection and 0.13 nm for the algorithms of the present disclosure. This means a phase error reduction by factor 6.9.

The phase error of a simple Least Squares Fit is as sensitive to vibrations as the phase error of a Fourier Transform. Both suffer from the fact, that all data points contribute equally.

The algorithms of the present disclosure specifically suppresses points where an interference contrast is low, thereby suppressing frames with vibration.

In at least one embodiment, the surface analysis server 810 receives 705 scan data of a sample object to be analyzed for phase shift interferometry (PSI). The scan data includes a plurality of images of the sample. Each image includes a plurality of pixels. The scan data is of a surface, potentially of a semiconductor wafer. The scan data is the scan data may be, for example, but not limited to, post-polishing nanotopography, silicon on insulator, or Epitaxial wafers. In some embodiments, the scan data includes both sides of the sample. The plurality of images includes a first plurality of images of a first side of the sample and a second plurality of images of a second side of the sample. The first plurality of images includes a first plurality of pixels and the second plurality of images includes a second plurality of pixels. In some further embodiments, the surface analysis server 810 analyzes both sides of the sample simultaneously. For the purposes of this discussion a scan case refers to the laser wavelength scan while taking a sequence of images. This is being done to create full surface maps.

In at least one embodiment, for each pixel of the plurality of pixels, the surface analysis server 810 generates 710 a sequence of interferences for a corresponding pixel of the plurality of pixels. The surface analysis server 810 generates a sequence of interferences for each pixel of the first plurality of pixels and each pixel of the second plurality of pixels

In at least one embodiment, for each pixel of the plurality of pixels, the surface analysis server 810 generates 715 a model from the sequence of interferences for the corresponding pixel.

In at least one embodiment, the surface analysis server 810 fits 720 the model with a weighted least squares method. In at least one embodiment, the weighted least squares method includes a plurality of weights. The surface analysis server 810 sets all of the plurality of weights to 1 for a first iteration of fitting the models with the weighted least squares method.

In at least one embodiment, for each pixel of the plurality of pixels, the surface analysis server 810 extracts 725 a phase from the fitted model.

In at least one embodiment, the surface analysis server 810 generates 730 a phase image from the plurality of phases from each pixel of the plurality of pixels

In some further embodiments, the surface analysis server 810 performs a statistical analysis of a plurality of zero transitions in the scan data. The plurality of zero transitions are based on a ring image 410 (shown in FIG. 4) from around the sample to be analyzed.

In some embodiments, the surface analysis server 810 analyzes the sample using the phase image. The surface analysis server 810 determines whether or not to approve the sample based on the analysis. Further the surface analysis server 810 determines whether or not to adjust one or more devices based on the analysis, such as a grinder and/or a polisher.

Systems and methods implementing the algorithms of the present disclosure can be used for inspection of any suitable semiconductor wafer product. Such systems and methods may suitably be used to characterize wafer thickness, shape, flatness metrics, and nanotopography of the wafer. While the above describes using the systems and processes described herein for analyzing silicon wafers, one having ordinary skill in the art would understand that these systems and methods may also be used for analyzing other surfaces.

FIG. 8 illustrates an example system 800 for performing the processes 600 and 700 (shown in FIGS. 6 and 7). In the example embodiment, the system 800 is used for phase shift interferometry utilizing logarithmized probability density fit of phase interference data. In other embodiments, system 800 is used for performing phase shift interferometry in which a robust least squares fit of a simple sine wave model with a custom robust weighting function applied.

As described below in more detail, a surface analysis server 810 is programmed to provide PSI data. The surface analysis server 810 is programmed to a) receive 605 scan data of a sample to be analyzed for phase shift interferometry (PSI), wherein the scan data includes a plurality of images of the sample, wherein each image includes a plurality of pixels; b) for each pixel of the plurality of pixels, i) generate 610 a sequence of interferences for a corresponding pixel of the plurality of pixels; ii) generate 615 a wave form from the sequence of interferences for the corresponding pixel; iii) generate 620 an approximated waveform based on the wave form and a non-normal distributed statistical distribution; iv) extract 625 a phase from the approximated waveform; and c) generate 630 a phase image from the plurality of phases from each pixel of the plurality of pixels (as shown in FIG. 6).

In the example embodiment, client devices 805 are computers that include a web browser or a software application, which enables client devices 805 to communicate with surface analysis server 810 using the Internet, a local area network (LAN), or a wide area network (WAN). In some embodiments, the client devices 805 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 805 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices.

In the example embodiment, the surface analysis computer device 810 (also known as surface analysis server 810) is a computer that include a web browser or a software application, which enables surface analysis server 810 to communicate with client devices 805 and cameras/sensors 625 using the Internet, a local area network (LAN), or a wide area network (WAN). In some embodiments, the surface analysis server 810 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The surface analysis server 810 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, voice bots, ChatGPT bots or ChatGPT-based bots, or other web-based connectable equipment or mobile devices. In some embodiments, the surface analysis server 810 includes one or more of the analyzer device 102, the first computing device 104, the second computing device 106, and the third computing device 108 (all shown in FIG. 1).

A database server 815 is communicatively coupled to a database 820 that stores data. In one embodiment, the database 820 is a database that includes a plurality of images from scans. In some embodiments, the database 820 is stored remotely from the surface analysis server 810. In some embodiments, the database 820 is decentralized. In the example embodiment, a person can access the database 820 via the client devices 805 by logging onto surface analysis server 810.

Camera/sensor 825 may be any camera and/or sensor that the surface analysis server 810 is in communication with that transmits images to the surface analysis server 810, such as the image capture device 122 (shown in FIG. 1). In the example embodiment, camera/sensors 825 that are in communication with surface analysis server 810 using the Internet, a local area network (LAN), or a wide area network (WAN). In some embodiments, the camera/sensor(s) 825 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem.

FIG. 9 depicts an example configuration 900 of user computer device 902. In the example embodiment, user computer device 902 may be similar to, or the same as, client device 805 (shown in FIG. 18). User computer device 902 may be operated by a user 901.

User computer device 902 may include a processor 905 for executing instructions. In some embodiments, executable instructions may be stored in a memory area 910. Processor 905 may include one or more processing units (e.g., in a multi-core configuration). Memory area 910 may be any device allowing information such as executable instructions and/or transaction data to be stored and retrieved. Memory area 910 may include one or more computer readable media.

User computer device 902 may also include at least one media output component 915 for presenting information to user 901. Media output component 915 may be any component capable of conveying information to user 901. In some embodiments, media output component 915 may include an output adapter (not shown) such as a video adapter and/or an audio adapter. An output adapter may be operatively coupled to processor 905 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 915 may be configured to present a graphical user interface (e.g., a web browser and/or a client application) to user 901. A graphical user interface may include, for example, an interface for viewing items of information provided by the surface analysis server 810 (shown in FIG. 8). In some embodiments, user computer device 902 may include an input device 920 for receiving input from user 901. User 901 may use input device 920 to, without limitation, submit information either through speech or typing.

Input device 920 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 915 and input device 920.

User computer device 902 may also include a communication interface 925, communicatively coupled to a remote device such as surface analysis server 810. Communication interface 925 may include, for example, a wired or wireless network adapter and/or a wireless data transceiver for use with a mobile telecommunications network.

Stored in memory area 910 are, for example, computer readable instructions for providing a user interface to user 901 via media output component 915 and, optionally, receiving and processing input from input device 920. A user interface may include, among other possibilities, a web browser and/or a client application. Web browsers enable users, such as user 901, to display and interact with media and other information typically embedded on a web page or a website from surface analysis server 810. A client application may allow user 901 to interact with, for example, surface analysis server 810. For example, instructions may be stored by a cloud service, and the output of the execution of the instructions sent to the media output component 915.

FIG. 10 depicts an example configuration 1000 of a server computer device 1002. In the example embodiment, server computer device 1002 may be similar to, or the same as, surface analysis server 810 and database server 815 (both shown in FIG. 8). Server computer device 1002 may also include a processor 1005 for executing instructions. Instructions may be stored in a memory area 1010. Processor 1005 may include one or more processing units (e.g., in a multi-core configuration).

Processor 1005 may be operatively coupled to a communication interface 1015 such that server computer device 1002 is capable of communicating with a remote device such as another server computer device 1002, surface analysis server 810, camera/sensors 825, and client devices 805 (shown in FIG. 8) (for example, using wireless communication or data transmission over one or more radio links or digital communication channels). For example, communication interface 1015 may receive input from client devices 805 via the Internet, as illustrated in FIG. 8.

Processor 1005 may also be operatively coupled to a storage device 1025. Storage device 1025 may be any computer-operated hardware suitable for storing and/or retrieving data, such as, but not limited to, data associated with one or more models. In some embodiments, storage device 1025 may be integrated in server computer device 1002. For example, server computer device 1002 may include one or more hard disk drives as storage device 1025.

In other embodiments, storage device 1025 may be external to server computer device 1002 and may be accessed by a plurality of server computer devices 1002. For example, storage device 1025 may include a storage area network (SAN), a network attached storage (NAS) system, and/or multiple storage units such as hard disks and/or solid-state disks in a redundant array of inexpensive disks (RAID) configuration.

In some embodiments, processor 1005 may be operatively coupled to storage device 1025 via a storage interface 1020. Storage interface 1020 may be any component capable of providing processor 1005 with access to storage device 1025. Storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1005 with access to storage device 1025.

Processor 1005 may execute computer-executable instructions for implementing aspects of the disclosure. In some embodiments, the processor 1005 may be transformed into a special purpose microprocessor by executing computer-executable instructions or by otherwise being programmed. For example, the processor 1005 may be programmed with the instruction such as illustrated in FIGS. 6 and 7.

At least one of the technical problems addressed by this system may include: (i) improve analysis of surfaces, such as wafers; (ii) decreased loss of material due to malfunction; (iii) earlier determination of wafer quality; (iv) increased accuracy in wafer analysis; (v) reduced computational resources required for surface analysis; (vi) increased speed of surface analysis; and/or (v) increased accuracy in wafer analysis.

A technical effect of the systems and processes described herein may be achieved by performing at least one of the following steps: a) receive scan data of a sample to be analyzed for phase shift interferometry (PSI), wherein the scan data includes a plurality of images of the sample, wherein each image includes a plurality of pixels; b) for each pixel of the plurality of pixels, generate a sequence of interferences for a corresponding pixel of the plurality of pixels; c) for each pixel of the plurality of pixels, generate a wave form from the sequence of interferences for the corresponding pixel; d) for each pixel of the plurality of pixels, generate an approximated waveform based on the wave form and a non-normal distributed statistical distribution; e) for each pixel of the plurality of pixels, extract a phase from the approximated waveform; f) generate a phase image from the plurality of phases from each pixel of the plurality of pixels; g) for each pixel of the plurality of pixels, normalize values in the sequence of interferences into a range of +/−1; h) apply the same non-normal distributed statistical distribution to the wave forms for all of the plurality of pixels; i) wherein the scan data includes both sides of the sample; j) wherein the plurality of images includes a first plurality of images of a first side of the sample and a second plurality of images of a second side of the sample, wherein the first plurality of images includes a first plurality of pixels and the second plurality of images includes a second plurality of pixels; k) generate a sequence of interferences for each pixel of the first plurality of pixels and each pixel of the second plurality of pixels; l) analyze both sides of the sample simultaneously; m) wherein the sample to be analyzed is a circular, semiconductor wafer; n) analyze the sample using the phase image; o) determine whether or not to approve the sample based on the analysis; p) determine whether or not to adjust one or more devices based on the analysis; q) determine minima and maxima of the scan data; r) normalize the scan data into a range from −1 to +1; s) wherein one or more parameters of the wave form are determined by properties of a material used for the sample; t) wherein one or more parameters of the wave form are determined by a reference plane used during scanning; u) eliminate outliers beyond a threshold; and/or v) wherein the scan data is post-polishing nanotopography.

Additional technical effects of the systems and processes described herein may be achieved by performing at least one of the following steps: a) receive scan data of a sample to be analyzed for phase shift interferometry (PSI), wherein the scan data includes a plurality of images of the sample, wherein each image includes a plurality of pixels; b) for each pixel of the plurality of pixels, generate a sequence of interferences for a corresponding pixel of the plurality of pixels; c) for each pixel of the plurality of pixels, generate a model from the sequence of interferences for the corresponding pixel; d) for each pixel of the plurality of pixels, fit the model with a weighted least squares method; e) for each pixel of the plurality of pixels, extract a phase from the fitted model; and f) generate a phase image from the plurality of phases from each pixel of the plurality of pixels; g) wherein the sample to be analyzed is a circular, semiconductor wafer; h) wherein the scan data includes both sides of the sample; i) wherein the plurality of images includes a first plurality of images of a first side of the sample and a second plurality of images of a second side of the sample, wherein the first plurality of images includes a first plurality of pixels and the second plurality of images includes a second plurality of pixels; j) generate a sequence of interferences for each pixel of the first plurality of pixels and each pixel of the second plurality of pixels; k) analyze both sides of the sample simultaneously; l) wherein the weighted least squares method includes a plurality of weights; m) wherein all of the plurality of weights are set to 1 for a first iteration of fitting the model with the weighted least squares method; n) perform a statistical analysis of a plurality of zero transitions in the scan data; o) wherein the plurality of zero transitions are based on a ring image from around the sample to be analyzed; p) wherein the scan data is post-polishing nanotopography; q) analyze the sample using the phase image; r) determine whether or not to approve the sample based on the analysis; and/or s) determine whether or not to adjust one or more devices based on the analysis.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a reduced instruction set circuit (RISC), an application specific integrated circuit (ASIC), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer device comprising at least one processor in communication with at least one memory device, wherein the at least one processor programmed to:
receive scan data of a sample to be analyzed for phase shift interferometry (PSI), wherein the scan data includes a plurality of images of the sample, wherein each image includes a plurality of pixels;
for each pixel of the plurality of pixels, generate a sequence of interferences for a corresponding pixel of the plurality of pixels;
for each pixel of the plurality of pixels, generate a wave form from the sequence of interferences for the corresponding pixel;
for each pixel of the plurality of pixels, generate an approximated waveform based on the wave form and a non-normal distributed statistical distribution;
for each pixel of the plurality of pixels, extract a phase from the approximated waveform; and
generate a phase image from the plurality of phases from each pixel of the plurality of pixels.

2. The computer device of claim 1, wherein the at least one processor is further programmed to for each pixel of the plurality of pixels, normalize values in the sequence of interferences into a range of +/−1.

3. The computer device of claim 1, wherein the at least one processor is further programmed to apply the same non-normal distributed statistical distribution to the wave forms for all of the plurality of pixels.

4. The computer device of claim 1, wherein the scan data includes both sides of the sample.

5. The computer device of claim 4, wherein the plurality of images includes a first plurality of images of a first side of the sample and a second plurality of images of a second side of the sample, wherein the first plurality of images includes a first plurality of pixels and the second plurality of images includes a second plurality of pixels.

6. The computer device of claim 5, wherein the at least one processor is further programmed to generate a sequence of interferences for each pixel of the first plurality of pixels and each pixel of the second plurality of pixels.

7. The computer device of claim 4, wherein the at least one processor is further programmed to analyze both sides of the sample simultaneously.

8. The computer device of claim 1, wherein the sample to be analyzed is a circular, semiconductor wafer.

9. The computer device of claim 1, wherein the at least one processor is further programmed to:
analyze the sample using the phase image; and
determine whether or not to approve the sample based on the analysis.

10. The computer device of claim 9, wherein the at least one processor is further programmed to determine whether or not to adjust one or more devices based on the analysis.

11. The computer device of claim 1, wherein the at least one processor is further programmed to:
determine minima and maxima of the scan data; and
normalize the scan data into a range from −1 to +1.

12. The computer device of claim 1, wherein one or more parameters of the wave form are determined by properties of a material used for the sample.

13. The computer device of claim 1, wherein one or more parameters of the wave form are determined by a reference plane used during scanning.

14. The computer device of claim 1, wherein the at least one processor is further programmed to eliminate outliers beyond a threshold.

15. The computer device of claim 1, wherein the scan data is post-polishing nanotopography.

16. A computer-implemented method for analyzing a sample, the computer-implemented method implemented by a computing device including at least one processor in communication with at least one memory device, the method comprising:
receiving scan data of a sample to be analyzed for phase shift interferometry (PSI), wherein the scan data includes a plurality of images of the sample, wherein each image includes a plurality of pixels;
for each pixel of the plurality of pixels, generating a sequence of interferences for a corresponding pixel of the plurality of pixels;
for each pixel of the plurality of pixels, generating a wave form from the sequence of interferences for the corresponding pixel;
for each pixel of the plurality of pixels, generating an approximated waveform based on the wave form and a non-normal distributed statistical distribution;
for each pixel of the plurality of pixels, extracting a phase from the approximated waveform; and
generating a phase image from the plurality of phases from each pixel of the plurality of pixels.

17. The computer-implemented method of claim 16 further comprising for each pixel of the plurality of pixels, normalizing values in the sequence of interferences into a range of +/−1.

18. The computer-implemented method of claim 16, wherein the at least one processor is further programmed to apply the same non-normal distributed statistical distribution to the wave forms for all of the plurality of pixels.

19. The computer-implemented method of claim 16, wherein the scan data includes both sides of the sample, wherein the plurality of images includes a first plurality of images of a first side of the sample and a second plurality of images of a second side of the sample, wherein the first plurality of images includes a first plurality of pixels and the second plurality of images includes a second plurality of pixels.

20. The computer-implemented method of claim 19, wherein the at least one processor is further programmed to analyze both sides of the sample simultaneously.

21-39. (canceled)
